(19) United States
(12) Patent Application Publication
(10) Pub. No.: US 2025/0033140 A1
(43) Pub. Date: Jan. 30, 2025

(54) METHOD FOR CONNECTING COMPONENTS USING FRICTION STIR WELDING AND DEVICE FOR CARRYING OUT A METHOD OF THIS TYPE

(71) Applicant: Stirtec GmbH, Kalsdorf bei Graz (AT)

(72) Inventors: Gunter FIGNER, Graz (AT); Lucas OPPENEIGER, Graz (AT); Christian PFEIFFER, Graz (AT); Ozan CALISKANOGLU, Graz (AT); Thomas WEINBERGER, Graz (AT); Roland RATHNER, Graz (AT)

(73) Assignee: Stirtec GmbH, Kalsdorf bei Graz (AT)

(21) Appl. No.: 18/715,216

(22) PCT Filed: Nov. 10, 2022
(86) PCT No.: PCT/AT2022/060390

§ 371 Date: Jun. 10, 2024

(30) Foreign Application Priority Data
Dec. 3, 2021 (AT) A 50968/2021

(51) Int. Cl. B23K 20/12; B23K 20/233

(52) U.S. Cl. CPC B23K 20/1255; B23K 20/123; B23K 20/2336

(57) ABSTRACT

A method for connecting components using friction stir welding and a device for carrying out the stir friction welding method. A friction stir welding tool having a pin and a shoulder rotates about an axis of rotation and is moved along an advancement direction to connect the components. To obtain a high-quality weld with a simultaneously high welding speed, a friction stir welding tool having a shoulder movable relative to the pin is used and a rotational speed of the pin about the axis of rotation corresponds to at least 1.15 times, preferably at least 1.5 times, in particular 2 to 12 times, the rotational speed of the shoulder about the axis of rotation. The advancement speed is at least 1.0 m/min, preferably 2.0 m/min to 15 m/min.

The invention relates to a method for connecting components using friction stir welding, wherein a friction stir welding tool having a pin and a shoulder rotates about an axis of rotation and is moved along an advancement direction in order to connect the components.

The invention furthermore relates to a device for carrying out a friction stir welding method using a friction stir welding tool having a pin and a shoulder.

Methods and devices of the type named at the outset are well known from the prior art, so that friction stir welding now counts as a welding process widely used in the industrial sector. A disadvantage of friction stir welding methods implemented at the present time is that only comparatively low welding speeds are achieved. It has thus been shown that increasing an advancement speed leads to welding defects starting at approximately 1.0 m/min, for which reason an industrially desired reduction of cycle times is not currently possible using friction stir welding methods from the prior art for process-related reasons.

This is addressed by the invention. The object of the invention is to specify a method of the type named at the outset with which components can be connected in a high-quality manner even at higher speeds using friction stir welding.

Additionally, a device for carrying out a corresponding method is to be specified.

According to the invention, the first object is attained with a method of the type named at the outset in which a friction stir welding tool having a shoulder that can be moved relative to the pin is used and a rotational speed of the pin about the axis of rotation corresponds to at least 1.15 times, preferably at least 1.5 times, in particular 2 to 12 times, the rotational speed of the shoulder about the axis of rotation, wherein the advancement speed is at least 1.0 m/min, preferably 2.0 m/min to 15 m/min.

In the course of the invention, it was found that welding defects at higher advancement speeds occur because, in order to attain similar process temperatures as in the case of lower advancement speeds, more heat per unit of time must be generated by the tool, but increasing the rotational speed of the friction stir welding tool results in problems, in particular in the region of the shoulder, especially since an overheating then occurs in the shoulder region and, in order to avoid an undesired dipping of the tool into the components being connected, a forging pressure would need to be reduced. Therefore, in order to attain a necessary process temperature in the region of the pin, a rotational speed of the friction stir welding tool would be required which would lead to impermissibly high temperatures in the region of the shoulder and to a high temperature gradient in the region of a joining zone. An asymmetry of a temperature distribution over a sheet thickness of the components being welded which leads to it tending to be too cool in the region of the pin, or in the region of a pin tip, and it tending to be too hot on a top side of the weld, also occurs at low advancement speeds; in this case, however, the temperature difference is compensated to a good to full extent by the thermal conduction in the components being welded or in the weld.

At higher advancement speeds, a compensation of this type no longer takes place; rather, a temperature difference increases as the advancement speed increases, which temperature difference cannot be compensated solely by increasing the rotational speed of the friction stir welding tool without defects occurring in the weld, for which reason a maximum advancement speed is limited in conventional friction stir welding methods at the present time.

If a method according to the invention is carried out, this asymmetry in the region of the temperature distribution is thus easily avoided in that the pin rotates at a higher speed than the shoulder. A lower heat generation in the region of the pin due to a smaller circumference of the pin and a smaller frontal area compared to the shoulder area is thus compensated by a higher circumferential speed of the pin. As a result of the lower circumferential speed of the shoulder, a risk of an overheating on the top side of the weld is reduced or prevented and, because of the reduced temperature in the region of the shoulder, the forging force can be increased without the tool dipping into the workpiece or into the components being connected.

The forging force is typically understood as the force with which the friction stir welding tool is pressed axially, or parallel to the axis of rotation, against the components being welded. A forging force or axial force of this type is normally applied and maintained during the entire welding process.

In a method according to the invention, it is preferably provided that the advancement speed is 1.5 m/min to 10 m/min. Particularly low cycle times and, similarly, a high quality of the weld can thus be obtained.

Furthermore, it is preferably provided that the rotational speed of the pin about the axis of rotation corresponds to 2 times to 12 times, in particular 3 times to 8 times, preferably approximately 4 times, the rotational speed of the shoulder about the axis of rotation. In this manner, it is possible to achieve beneficial temperatures even at high advancement speeds of, for example, 2 m/min to 10 m/min both in the region of the pin, or of a bottom side of the weld, and in the region of the shoulder, or of a top side of the weld, whereby welding defects can be avoided.

In the course of the invention, it was found that a ratio of the rotational speed of the shoulder to the rotational speed of the pin is preferably selected depending on the advancement speed. In this regard, it has proven especially effective if a ratio of the rotational speed of the pin (symbol: n_{P}) to the rotational speed of the shoulder (symbol: n_{S}) satisfies the following conditions as a function of the advancement speed (symbol: v):

$${A}_{1} \cdot {v}^{2} + {B}_{1} < \frac{{n}_{P}}{{n}_{S}} < {A}_{2} \cdot {v}^{2} + {B}_{2}$$

wherein the constants A₁, B₁, A₂, and B₂ have the following values:
A₁=0.17 (min/m)²;
A₂=0.25 (min/m)²;
B₁=1;
B₂=1.8.

Thus, generally speaking, a range of a preferred ratio of the rotational speed of the pin to the rotational speed of the shoulder increases approximately quadratically with the advancement speed.

In addition, it was surprisingly shown that a ratio of the rotational speed of the pin (n_{P}) to the rotational speed of the shoulder (n_{S}) is particularly preferably chosen in an advancement speed (v) range of 4 m/min to 10 m/min, resulting in a greater than quadratic relationship between advancement speed and the ratio of the speed of the pin to the speed of the shoulder. In this regard, it is particularly favorable if, for an advancement speed (v) of 4 m/min to 10 m/min, a ratio of the rotational speed of the pin (n_{P}) to the rotational speed of the shoulder (n_{S}) satisfies the following condition as a function of the advancement speed (v):

$${C}_{1} \cdot {( v - D )}^{2.15} + {E}_{1} < \frac{{n}_{P}}{{n}_{S}} < {C}_{2} \cdot {( v - D )}^{2.15} + {E}_{2}$$

wherein the constants C₁, D, E₁, C₂, and E₂ have the following values:
C₁=0.6 (min/m)^{2.15};
C₂=0.6 (min/m)^{2.15};
D=4 m/min;
E₁=3 to 5, in particular 4;
E₂=6 to 8, in particular 7.

This unexpectedly discovered relationship, in which the advancement speed is included more than quadratically, could be explained in a physical sense by the fact that the heat generation increases quadratically with the speed and, furthermore, that a temperature directly in front of the friction stir welding tool is also lower the higher the advancement speed is. Thus, especially for the advancement speed range of 4 m/min to 10 m/min, a particularly high quality with a simultaneously low cycle time can be achieved with a corresponding selection of the speed ratio.

It is preferably provided that at least one of the components, preferably both components, is composed of aluminum or an aluminum alloy, in particular of an aluminum alloy with a silicon proportion of more than 2%.

It has proven beneficial if the rotational speed of the pin is 6.000 rpm to 8,000 rpm. As a result, it is possible to connect components in a high-quality manner using friction stir welding, wherein advancement speeds of, for example, 10 m/min are feasible.

Furthermore, it has proven effective that a friction stir welding tool is used which comprises a pin that is composed of a material having a hardness of at least 70 H RC. As a result, an abrasive wear on the pin in particular can be considerably reduced. Thus, in the case of aluminum alloys having a silicon alloy constituent of more than 2% in particular, it has been shown that a high abrasive wear acts on the pin, which wear can be significantly reduced by selecting a pin made of a material with a corresponding hardness.

In addition, it is beneficial if a friction stir welding tool is used which comprises a pin that is composed of a material having a bending strength of at least 1,700 N/mm². It has thus been shown that, with increased advancement speed, a bending stress on the pin is also higher and, by selecting a material having a corresponding bending strength, a fracturing of the pin can be avoided.

In order to avoid an undesirable fracturing of the pin in a particularly reliable manner even at high advancement speeds, it is particularly beneficial if a friction stir welding tool is used which comprises a pin that is composed of a material having a fracture toughness of at least 8.3 MNm^{-3/2}.

Such characteristics can be obtained with widely differing materials. It is particularly beneficial if a friction stir welding tool is used which comprises a pin that is composed of a solid carbide, a highly abrasive alloy, and/or a ceramic, in particular cubic boron nitride or polycrystalline cubic boron nitride.

It is particularly beneficial if the pin comprises mechanically and chemically beneficial properties in a region close to the surface. It can therefore be advantageous if a friction stir welding tool is used which comprises a pin that has a coating, in particular a CVD coating and/or a PVD coating.

It has proven effective that a friction stir welding tool is used which comprises a shoulder that has a lower hardness than the pin of the friction stir welding tool. A combination of abrasive and adhesive wear thus occurs in the region of the shoulder, which is why a material having lower hardness can be sufficient in the region of the shoulder.

It is beneficial if a friction stir welding tool is used which comprises a shoulder that has a hardness of at least 50 HRC. The shoulder can, for example, be formed by a carbide, a ceramic, or the like.

It is advantageous if a rotational speed of the pin is altered during the method, whereas a torque with which the pin is driven and/or a torque with which the shoulder is driven essentially remain constant. In conventional friction stir welding, a rotational speed of the tool must be increased as the advancement speed increases, in order to be able to introduce an equal amount of energy at a point of the weld for a shorter holding time. It has thereby been shown that, through the higher rotational speed of the tool, a fluidity of the material in the stirring zone is increased, so that a friction coefficient is reduced and the tool “slips” more. Accordingly, in classic friction stir welding, with increasing rotational speed, constant advancement speed, and constant contact pressure of the tool against the components being welded, a torque decreases due to a decreasing friction coefficient, whereby a further increase in the rotational speed is necessary to be able to introduce a required amount of energy, especially since the introduced output is defined by a product of the torque and rotational speed. This, in turn, increases the fluidity in the stirring zone and further reduces the friction coefficient, which is why, in the case of classic friction stir welding, the rotational speed, and therefore also the advancement speed, can only be increased within narrow limits.

Because the rotational speed of the shoulder is lower relative to the rotational speed of the pin, the method according to the invention can be used to avoid an undesired increase in the fluidity of the material in the stirring zone, so that an unfavorable reduction in the friction coefficient can be prevented. With a corresponding selection of a rotational speed of the pin and a rotational speed of the shoulder, it is thus possible even at higher rotational speeds of the pin to maintain a high friction coefficient that is otherwise only attainable with low rotational speeds, whereby a high torque can also be maintained at a correspondingly high rotational speed of the pin. As a result, a higher advancement speed can also be realized, for which reason a high welding speed with a consistently high quality is attained with a method of this type.

Accordingly, it is advantageous if a rotational speed of the pin is altered during the method, whereas a torque with which the pin is driven and/or a torque with which the shoulder is driven essentially remain constant.

The method can thus be controlled, for example, such that, with a constant contact pressure with which the friction stir welding tool is axially pressed against the components being connected, and with a constant advancement speed, the rotational speed of the pin and/or shoulder are increased until a drop in the torque of the pin and/or of the shoulder is detected, which drop indicates a slipping of the friction stir welding tool or a drop in the friction coefficient, whereupon in particular the rotational speed of the shoulder is reduced until the torque of the pin and/or the torque of the shoulder increases again or reaches a setpoint value.

Alternatively or additionally, the advancement speed or the contact pressure can also be varied, so that these parameters can be changed by a closed-loop control, in particular in an automated manner, in which closed-loop control a measured torque of the pin and/or shoulder are control variables which are compared with setpoint values. A deviation of the measured torques from the respective setpoint values thus causes a change in one or more of these parameters.

Based on the finding that a reduction in the friction coefficient between the friction stir welding tool and the components can be reduced by a rotational speed of the shoulder that is reduced compared to the rotational speed of the pin, the method according to the invention can also be controlled such that a decrease in the friction coefficient can be reliably avoided by adjusting the rotational speed of the shoulder and/or of the pin. The friction coefficient can thus be indirectly measured via the torques. It is therefore advantageous if a torque with which the shoulder is driven and a torque with which the pin is driven are measured, preferably continuously during the method. Sensors, in particular strain gauges, torque sensors, or the like, can be provided for this purpose. In principle, the torque can also be measured via an electric current of a motor or of a spindle which drives the pin or the shoulder.

Based on correspondingly measured torques, it is also preferably provided that the torque with which the shoulder is driven and/or the torque with which the pin is driven is continuously measured and compared with a setpoint value, and the rotational speed of the shoulder is reduced if a magnitude of the torque with which the shoulder is driven and/or a magnitude of the torque with which the pin is driven is less than 90%, preferably less than 80%, in particular less than 70%, of the setpoint value. In this manner, it is possible to respond in an automated manner to a drop in the friction coefficient in the stirring zone with a reduction in the rotational speed of the shoulder, in order to avoid an undesired slipping of the friction stir welding tool in the stirring zone. The method thus ensures a maximum possible speed depending on the local conditions in the stirring zone.

It shall be understood that different setpoint values can be provided for the torque with which the pin is driven and the torque with which the shoulder is driven.

Based on one or more setpoint values for the torque of the pin and the torque of the shoulder, a rotational speed can, of course, also be increased. In this context, it is preferably provided that the torque with which the shoulder is driven and/or the torque with which the pin is driven is continuously measured and compared with a setpoint value, and the rotational speed of the shoulder is increased if a magnitude of the torque with which the shoulder is driven and/or a magnitude of the torque with which the pin is driven is more than 110%, preferably more than 120%, in particular more than 130%, of the setpoint value. An increase in the rotational speed of the shoulder increases a fluidity in the stirring zone and thus leads to a reduction in the friction coefficient, which is why the torque decreases as the rotational speed rises. Here, it is of course also possible to provide different setpoint values for the torque with which the pin is driven and the torque with which the shoulder is driven.

In order to reduce or to prevent a slipping of the friction stir welding tool in the stirring zone, which slipping is detected via a drop in the torque, it is in principle possible to reduce both the rotational speed of the pin and the rotational speed of the shoulder. In order to obtain a good stirring and therefore a high weld quality even with a high advancement speed, it is preferably provided that the rotational speed of the pin is not altered, or is altered to a lesser extent than the rotational speed of the shoulder. In other words, a reduction in the friction coefficient in the stirring zone is preferably avoided by varying the rotational speed of the shoulder, or a temperature in the stirring zone is essentially adjusted via the rotational speed of the shoulder, so that the pin can essentially be used to stir the components in the stirring zone.

The measured torques can also be used to control the advancement speed, wherein the advancement speed is included in the closed-loop control as an independent variable and the torque of the pin and/or the torque of the shoulder as dependent variables. It can thereby be provided that an advancement speed is increased with a constant rotational speed of the pin and shoulder, as long as a magnitude of the torque with which the shoulder is driven and/or a magnitude of the torque with which the pin is driven deviates from a setpoint value by less than 30%, in particular less than 20%, preferably less than 10%.

The setpoint value typically corresponds to a value of the torque at which a high quality of the weld can be obtained and can, for example, be determined within the scope of experiments or mathematically.

Thus, using the change in the advancement speed to regulate the measured torques to one or more defined setpoints, which are thus typically included in the closed-loop control as control variables dependent on the advancement speed, it can be guaranteed that favorable conditions are ensured in the region of the weld that is to be formed, or in the stirring zone, even in the case of high advancement speed.

The measured torque can also be used to determine the condition of the friction stir welding tool. On the one hand, in the case of a coated friction stir welding tool, a consumption of the coating can, due to a change in friction coefficient, produce a change in the torque with otherwise constant ambient conditions.

On the other hand, a larger gap between the pin and shoulder due to increasing wear can likewise produce a higher torque if the pin and shoulder have different rotational speeds, especially since more material, in particular aluminum from the components being connected, can accumulate in the gap in the case of a larger gap, which material causes greater friction between the pin and shoulder. It can therefore be beneficial if a tool wear is deduced on the basis of the measured torque and/or on the basis of a measured change in torque and the friction stir welding tool is replaced when a predefined wear is exceeded.

According to the invention, the other object is attained by a device of the type named at the outset in which the pin of the friction stir welding tool can be rotated relative to the shoulder about an axis of rotation of the friction stir welding tool, wherein the device is configured to move the friction stir welding tool at an advancement speed of at least 1.0 m/min, preferably 1.5 m/min to 15 m/min, along an advancement direction, and to drive the pin about the axis of rotation at a rotational speed which corresponds to at least 1.15, preferably at least 1.5, in particular 2 to 12 times, the rotational speed of the shoulder about the axis of rotation.

This enables the production of welds with high speed and a simultaneously high quality using friction stir welding. Typically, the device is used to carry out a method according to the invention. The pin and shoulder are thus separate components that can be driven about the axis of rotation at different speeds. Normally, the pin and shoulder are embodied roughly cylindrically and arranged coaxially, and are moved synchronously along the advancement direction. Furthermore, the pin and shoulder are typically pressed axially, or along the axis of rotation, with an approximately equal force onto the components being connected, though it can in principle also be provided that the pin and shoulder are pressed with different forces or different pressures onto the components being welded.

From a design standpoint, a different speed of the pin and shoulder can be achieved in widely different ways. It is preferably provided that the pin and shoulder are connected via a gearing mechanism, in particular a planetary gear. The planetary gear can comprise a fixed or variable transmission between the pin and shoulder, which can be connected to different outputs of the planetary gear, in order to be able to adapt a transmission ratio to an advancement speed.

In addition, it can also be provided that the device is configured to drive the pin and shoulder of the friction stir welding tool independently from one another at different speeds. This can take place by means of a gearing mechanism, as well as with different drives, for example.

It is particularly beneficial if a separate spindle for the pin and a separate spindle for the shoulder are provided, in order to drive the pin and shoulder independently from one another. The two spindles can then be driven by different motors of the device, wherein a control device is typically provided in order to be able to correspondingly define a transmission ratio between a rotational speed of the pin and a rotational speed of the shoulder, preferably such that it depends on the advancement speed according to the mathematical conditions stated above.

As explained, it can be beneficial to control the method depending on torques with which the pin and/or the shoulder are driven, wherein the rotational speed of the pin, the rotational speed of the shoulder, the contact force of the tool against the components being welded, and/or an advancement force can be altered in order to obtain torques within predefined limits around a setpoint value. It is therefore beneficial if sensors are provided with which a torque with which the shoulder is driven and a torque with which the pin is driven can be measured.

Typically, the device is configured for the closed-loop control of the rotational speed of the shoulder and/or for the closed-loop control of the rotational speed of the pin as a function of the measured torques.

Furthermore, it can be provided that the device is configured for the modification or closed-loop control of the advancement speed and/or of the contact force with which the friction stir welding tool is axially pressed against the components being welded, as a function of the measured torques.

For this purpose, a data processing device is preferably provided with which a rotational speed of the pin, a rotational speed of the shoulder, an advancement speed, and/or the contact force can be altered, and which is connected to the sensors with which the torques are measured.

Additional features, benefits, and effects of the invention follow from the exemplary embodiment described below. The drawing which is thereby referenced shows the following:

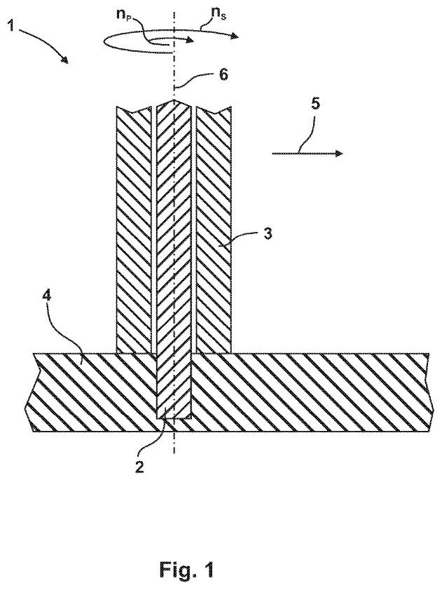

FIG. 1 shows a sectional illustration through a friction stir welding tool as a method according to the invention is being carried out;

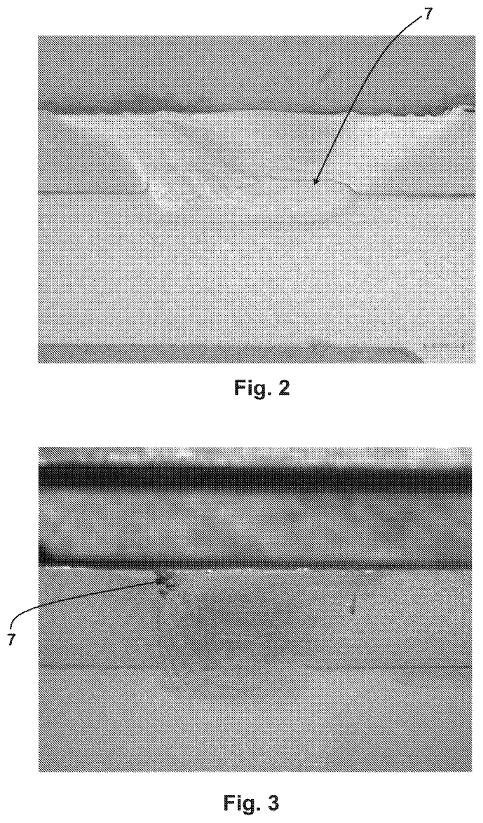

FIGS. 2 through 4 show micrographs of cross sections through welds.

FIG. 1 shows a section through a friction stir welding tool 1 as a method according to the invention is being carried out. As can be seen, the friction stir welding tool 1 comprises a shoulder 3 and a pin 2 protruding axially past the shoulder 3, which shoulder 3 and pin 2 are separate components 4 and can thus be moved relative to one another. The shoulder 3 is thereby formed by a hollow component 4 in which the pin 2 is arranged coaxially with the shoulder 3.

As is customary in friction stir welding, the friction stir welding tool 1 is pressed downward axially, or parallel to the axis of rotation 6, onto the components 4 being welded and is moved along an advancement direction 5, wherein the pin 2 and shoulder 3 rotate simultaneously about the axis of rotation 6 in order to connect the components 4 using friction stir welding.

The pin 2 and shoulder 3 can be moved relative to one another and can thus be moved about the axis of rotation at different rotational speeds, so that even in the case of high advancement speeds, a high heat input in the region of the pin 2 by the friction stir welding tool 1 and, at the same time, a reduced heat input in the region of the shoulder 3 are achieved.

With a friction stir welding tool 1 according to the invention, materials of the most widely different type can be welded together. For example, components 4 made of an aluminum alloy having a silicon proportion of more than 2% can be realized at different advancement speeds (symbol: v) of the friction stir welding tool 1 along the advancement direction 5 and at different ratios of the rotational speed of the shoulder 3 (symbol: n_{S}) to the rotational speed of the pin 2 (symbol: n_{P}) according to the following table:

| Advancement speed v | Pin-to-shoulder ratio of the |
|---|---|
| [m/min] | rotational speeds (n_{P}/n_{S}) |
| 1.5 | 2 |
| 4 | 5 |
| 5 | 6 |
| 6 | 8 |
| 7 | 12 |

As follows from the table, the ratio of the rotational speeds increases approximately quadratically with the advancement speed, and even greater than quadratically in an advancement speed range between 4 m/min and 7 m/min.

Thus, a ratio of rotational speeds of the pin 2 to the shoulder 3 (n_{P}/n_{S}) which depends on the advancement speed has generally proven advantageous, which ratio satisfies the following condition:

$${A}_{1} \cdot {v}^{2} + {B}_{1} < \frac{{n}_{P}}{{n}_{S}} < {A}_{2} \cdot {v}^{2} + {B}_{2}$$

wherein the constants A₁, B₁, A₂, and B₂ have the following values:
A₁=0.17 (min/m)²;
A₂=0.25 (min/m)²;
B₁=1;
B₂=1.8.

In the advancement speed range of 4 m/min to 10 m/min, a ratio of rotational speeds of the pin 2 to the shoulder 3 (n_{P}/n_{S}) which in particular depends on the advancement speed has proven to be especially advantageous for achieving high-quality welds with a simultaneously high welding speed, which ratio satisfies the following condition:

$${C}_{1} \cdot {( v - D )}^{2.15} + {E}_{1} < \frac{{n}_{P}}{{n}_{S}} < {C}_{2} \cdot {( v - D )}^{2.15} + {E}_{2}$$

wherein the constants C₁, D, E₁, C₂, and E₂ have the following values:
C₁=0.6 (min/m)²;
C₂=0.6 (min/m)²;
D=4 m/min;
E₁=3 to 5, in particular 4;
E₂=6 to 8, in particular 7.

The pin 2 of the friction stir welding tool 1 can, for example, be composed of a solid carbide, a highly abrasive alloy, and/or a ceramic, in particular cubic boron nitride or polycrystalline cubic boron nitride, and typically has a bending strength of at least 1,700 N/mm² and a fracture toughness of at least 8.3 MNm^{-3/2}, as well as a hardness of at least 70 HRC.

The shoulder 3 can, for example, be composed of a carbide or the like and typically has a lower hardness than the pin 2.

It can additionally be provided that a torque with which the shoulder 3 is driven and/or a torque with which the pin 2 is driven is continuously measured and compared with a setpoint value or two separate setpoint values, and that the rotational speed of the shoulder 3 is reduced if a magnitude of the torque with which the shoulder 3 is driven and/or a magnitude of the torque with which the pin 2 is driven is less than 90%, preferably less than 80%, in particular less than 70% of the respective setpoint value. It is thus possible, with otherwise constant parameters, in particular a constant advancement speed, to deduce from a drop in the torque an undesired reduction in the friction coefficient in the region of the weld being formed, or in a stirring zone, which reduction is caused by an excessively high amount of introduced energy due to a rotation of the shoulder 3. With a reduction in the rotational speed of the shoulder 3, more favorable conditions can thus once again be obtained in the stirring zone, and therefore a higher friction coefficient between the components 4 being connected and the friction stir welding tool.

Alternatively or additionally, the advancement speed can also be varied, in particular increased, and, based on an effect on the torque of the pin 2 and/or on the torque of the shoulder 3, a closed-loop control of the advancement speed can take place. Thus, with a constant rotational speed, an energy input into a region of the weld being formed, or into a stirring zone, can be varied by a change in the advancement speed. A higher advancement speed can thereby lead to a reduction in the energy input, especially since an interaction time of the friction stir welding tool with a point along the weld is reduced. Conversely, a lower advancement speed can produce an increase in an energy input, which can lead to a greater fluidity in the region of the stirring zone, and thus to a reduced friction coefficient.

In other words, it is possible to deduce the friction coefficient, and therefore conditions in the stirring zone, using the torque, and said conditions can be influenced by altering the rotational speed of the pin 2, the rotational speed of the shoulder 3, the advancement speed, and the contact force, for which reason conditions in the weld can be altered by changing one or more of these parameters, in order to obtain a weld with high quality and a simultaneously high welding speed.

FIGS. 2 through 4 show micrographs of welds on components 4 made of an aluminum alloy having a silicon proportion of more than 2%, which welds were formed using friction stir welding methods. FIGS. 2 and 3 thereby show cross sections of welds that were created using conventional methods. The weld depicted in FIG. 2 was, for example, created using an advancement speed of 2.5 m/min and a rotational speed of the pin 2 and shoulder 3 of 3,000 rpm. As can be seen, the weld exhibits defects 7 or bonding defects in a region of a bottom side of the weld, which defects are due to an excessively low temperature in the region of the pin 2.

The weld depicted in FIG. 3 was created using an advancement speed of 3 m/min and a rotational speed of the pin 2 and shoulder 3 of 5,300 rpm. Here, the temperature in the region of the pin 2, or of the bottom side of the weld, was adequate, but the temperature in the region of the shoulder 3, that is, of a top side of the weld, was too high, which is why defects 7 occurred on the top side of the weld in this case.

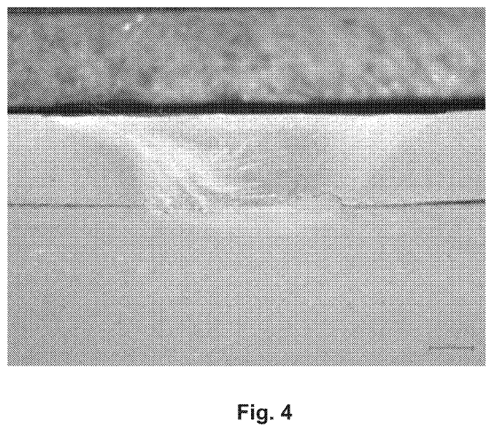

FIG. 4 shows a cross section of a weld produced using a method according to the invention. This weld was created using an advancement speed of 3 m/min, a rotational speed of the pin 2 of 7,000 rpm, and a rotational speed of the shoulder 3 of approximately 2,000 rpm. Accordingly, it was possible to attain appropriate temperatures both in the region of the pin 2 and in the region of the shoulder 3, for which reason the weld has been formed without welding defects.

With a method according to the invention and a corresponding device, the production of welds both with high speed and with a high quality is possible using friction stir welding, in particular in the case of aluminum components.

1. A method for connecting components using friction stir welding, wherein a friction stir welding tool having a pin and a shoulder rotates about an axis of rotation and is moved along an advancement direction in order to connect the components, wherein a friction stir welding tool having a shoulder that can be moved relative to the pin is used and a rotational speed of the pin about the axis of rotation corresponds to at least 1.15 times, preferably at least 1.5 times, in particular 2 to 12 times, the rotational speed of the shoulder about the axis of rotation, wherein the advancement speed is at least 1.0 m/min, preferably 2.0 mi/min to 15 m/min.

2. The method according to claim 1, wherein the advancement speed is 1.5 m/min to 10 m/min.

3. The method according to claim 1, wherein the rotational speed of the pin about the axis of rotation corresponds to 3 times to 8 times the rotational speed of the shoulder about the axis of rotation.

4. The method according to claim 1, wherein a ratio of the rotational speed of the pin, n_{P}, to the rotational speed of the shoulder, n_{S}, satisfies the following condition as a function of the advancement speed, v:
$${A}_{1} \cdot {v}^{2} + {B}_{1} < \frac{{n}_{P}}{{n}_{S}} < {A}_{2} \cdot {v}^{2} + {B}_{2}$$
wherein the constants A1, B1, A2, and B2 have the following values:
A1=0.17 (min/m)2;
A2=0.25 (min/m)2;
B1=1;
B2=1.8.

5. The method according to claim 1, wherein, for an advancement speed of 4 m/min to 10 m/min, a ratio of the rotational speed of the pin, n_{P}, to the rotational speed of the shoulder, n_{S}, satisfies the following condition as a function of the advancement speed, v:
$${C}_{1} \cdot {( v - D )}^{2.15} + {E}_{1} < \frac{{n}_{P}}{{n}_{S}} < {C}_{2} \cdot {( v - D )}^{2.15} + {E}_{2}$$
wherein the constants C1, D, E1, C2, and E2 have the following values:
C1=0.6 (min/m)2.15;
C2=0.6 (min/m)2.15;
D=4 m/min;
E1=3 to 5, in particular 4;
E2=6 to 8, in particular 7.

6. The method according to claim 1, wherein at least one of the components, preferably both components, is composed of aluminum or an aluminum alloy, in particular of an aluminum alloy with a silicon proportion of more than 2%.

7. The method according to claim 1, wherein the rotational speed of the pin is 6,000 rpm to 8,000 rpm.

8. The method according to claim 1, wherein a friction stir welding tool is used which comprises a pin that is composed of a material having a hardness of at least 70 HRC.

9. The method according to claim 1, wherein a friction stir welding tool is used which comprises a pin that is composed of a material having a bending strength of at least 1,700 N/mm².

10. The method according to claim 1, wherein a friction stir welding tool is used which comprises a pin that is composed of a material having a fracture toughness of at least 8.3 MNm^{-3/2}.

11. The method according to claim 1, wherein a friction stir welding tool is used which comprises a pin that is composed of a solid carbide, a highly abrasive alloy, and/or a ceramic, in particular cubic boron nitride or polycrystalline cubic boron nitride.

12. The method according to claim 1, wherein a friction stir welding tool is used which comprises a pin that has a coating, in particular a CVD coating and/or a PVD coating.

13. The method according to claim 1, wherein a friction stir welding tool is used which comprises a shoulder that has a lower hardness than the pin of the friction stir welding tool.

14. The method according to claim 1, wherein a friction stir welding tool is used which comprises a shoulder that has a hardness of at least 50 HRC.

15. The method according to claim 1, wherein a rotational speed of the pin is altered during the method, whereas a torque with which the pin is driven and/or a torque with which the shoulder is driven essentially remain constant.

16. The method according to claim 1, wherein a torque with which the shoulder is driven and a torque with which the pin is driven are measured, preferably continuously during the method.

17. The method according to claim 16, wherein the torque with which the shoulder is driven and/or the torque with which the pin is driven is continuously measured and compared with a setpoint value, and the rotational speed of the shoulder is reduced if a magnitude of the torque with which the shoulder is driven and/or a magnitude of the torque with which the pin is driven is less than 90%, preferably less than 80%, in particular less than 70%, of the setpoint value.

18. The method according to claim 1, wherein the torque with which the shoulder is driven and/or the torque with which the pin is driven is continuously measured and compared with a setpoint value, and the rotational speed of the shoulder is increased if a magnitude of the torque with which the shoulder is driven and/or a magnitude of the torque with which the pin is driven is more than 110%, preferably more than 120%, in particular more than 130%, of the setpoint value.

19. The method according to claim 17, wherein the rotational speed of the pin is altered to a lesser extent than the rotational speed of the shoulder, in particular not at all.

20. The method according to claim 1, wherein an advancement speed is increased with a constant rotational speed of the pin and shoulder, as long as a magnitude of the torque with which the shoulder is driven and/or a magnitude of the torque with which the pin is driven deviates from a setpoint value by less than 30%, in particular less than 20%, preferably less than 10%.

21. The method according to claim 16, wherein a tool wear is deduced on the basis of the measured torque and/or on the basis of a measured change in torque and the friction stir welding tool is replaced when a predefined wear determined in such a manner is exceeded.

22. A device for carrying out a friction stir welding method using a friction stir welding tool having a pin and a shoulder, in particular for carrying out a method according to claim 1, wherein the pin of the friction stir welding tool can be rotated relative to the shoulder about an axis of rotation of the friction stir welding tool, wherein the device is configured to move the friction stir welding tool at an advancement speed of at least 1.0 m/min, preferably 1.5 m/min to 15 m/min, along an advancement direction, and to drive the pin about the axis of rotation at a rotational speed which corresponds to at least 1.15, preferably at least 1.5, in particular 2 to 12 times, the rotational speed of the shoulder about the axis of rotation.

23. The device according to claim 22 wherein the pin and shoulder are connected via a gearing mechanism, in particular a planetary gear.

24. The device according to claim 22, wherein the device is configured to drive the pin and shoulder of the friction stir welding tool independently from one another at different speeds.

25. The device according to claim 22, wherein a separate spindle for the pin and a separate spindle for the shoulder are provided, in order to drive the pin and shoulder independently from one another.

26. The device according to claim 22, wherein one or more sensors are provided with which a torque with which the shoulder is driven and/or a torque with which the pin is driven can be measured.

27. The device according to claim 26, wherein the device is configured for the closed-loop control of the rotational speed of the shoulder and/or for the closed-loop control of the rotational speed of the pin as a function of the measured torques.
